(19) United States
(12) Patent Application Publication
(10) Pub. No.: US 2025/0305682 A1
(43) Pub. Date: Oct. 2, 2025

(54) RANGE HOOD AND CONTROL METHOD THEREFOR

(71) Applicant: SAMSUNG ELECTRONICS CO., LTD., Suwon-si (KR)

(72) Inventors: Duckjin SUNG, Suwon-si (KR); Yujeub HA, Suwon-si (KR); Eonjoong KIM, Suwon-si (KR); Semin LEE, Suwon-si (KR); Sangjun PARK, Suwon-si (KR); Sanggyun YE, Suwon-si (KR)

(73) Assignee: SAMSUNG ELECTRONICS CO., LTD., Suwon-si (KR)

(21) Appl. No.: 19/237,956

(22) Filed: Jun. 13, 2025

Related U.S. Application Data
(63) Continuation of application No. PCT/KR2024/002061, filed on Feb. 14, 2024.

(30) Foreign Application Priority Data
Mar. 7, 2023 (KR) 10-2023-0029599

(51) Int. Cl. F24C 15/20; F24C 3/12

(52) U.S. Cl. CPC F24C 15/2021; F24C 3/126; F24C 15/2042

(57) ABSTRACT

A range hood and a control method therefor. The range hood comprises: a housing; at least one thermal imaging camera disposed on a rear side of the housing; and at least one processing circuitry electrically connected to the at least one thermal imaging camera. The at least one processing circuitry obtains a thermal image through the at least one thermal imaging camera, obtains a temperature of an object included in the thermal image, and determine, based on a changing trend of the temperature, an estimated time required for the temperature to reach a preset target temperature, so as to display same on a display, and the estimated required time is determined after a predetermined time has elapsed from a time the temperature of the object is identified to when a change in the temperature of the object included in the thermal image is detected.

### CROSS-REFERENCE TO RELATED APPLICATIONS

This application is a continuation application of International Application No. PCT/KR2024/002061, filed on Feb. 14, 2024, in the Korean Intellectual Property Receiving Office, which claims priority from Korean Patent Application No. 10-2023-0029599, filed on Mar. 7, 2023, in the Korean Intellectual Property Office, the disclosures of which are hereby incorporated by reference herein in their entireties.

### TECHNICAL FIELD

The disclosure relates to a range hood and a method for controlling the same.

### BACKGROUND ART

A range hood is a kitchen appliance designed to remove airborne contaminants generated during cooking, helping to maintain clean air in the kitchen. Typically installed above a cooking appliance such as a cooktop, a range hood removes smoke, odors, and other byproducts of the cooking process. Range hoods may come in a variety of types and sizes. Range hoods typically include a filter, a fan, and an exhaust pipe. The fan of the range hood draws in air containing contaminants, which are then filtered out by the filter. The contaminant-free air may then be discharged outside through the exhaust pipe.

Beyond air purification, range hoods may also interwork with various electronic devices to offer various user services. For example, a range hood may receive commands from another electronic device to operate automatically, or it may send commands to allow another electronic device to perform predetermined operations.

### DISCLOSURE OF INVENTION

### Solution to Problems

The disclosure provides a range hood and a control method thereof capable of measuring the temperature of a cooking vessel or food item over a cooktop based on a thermal image and providing an estimated time required for cooking to another electronic device according to the measured temperature.

The disclosure provides a range hood and a control method thereof capable of measuring the temperature of a cooking vessel or food item over a cooktop based on a thermal image and controlling the cooktop interworking therewith according to the measured temperature.

According to an aspect of the disclosure, a range hood may comprise a housing, at least one thermal imaging camera to be disposed on a rear side of the housing, and at least one processing circuitry electrically connectable to the at least one thermal imaging camera. The at least one processing circuitry may obtain a thermal image through the thermal imaging camera, identify a temperature of an object included in the thermal image, determine an estimated time required for the temperature of the object to reach a preset target temperature based on a changing trend in the temperature of the object, and display the estimated time on a display. The estimated time may be determined after a predetermined time has elapsed from a time the temperature of the object is identified to when a change in the temperature of the object included in the thermal image is detected.

According to an embodiment, the range hood may further comprise at least one RGB camera. The RGB camera may be disposed on the rear side of the housing.

According to an embodiment, the at least one RGB camera and the at least one thermal imaging camera may be arranged adjacent to each other.

According to an embodiment, the at least one RGB camera may be disposed closer to a front side of the housing than the at least one thermal imaging camera.

According to an embodiment, the processing circuitry may obtain an RGB image using the RGB camera, identify a food item or a cooking vessel included in the RGB image, sets a first region of interest (ROI) corresponding to the food item or the cooking vessel, set a second ROI in the thermal image to be mapped to the first ROI, and identify a temperature of the food item or the cooking vessel based on the second ROI.

According to an embodiment, the estimated time may include a first estimated time measured at a first time and a second estimated time measured at a second time after the first time. An interval between the first time and the second time may be set to be constant.

According to an embodiment, the estimated time may further include a third estimated time measured at a third time between the first time and the second time. The third estimated time may be measured by the at least one processing circuitry based on identifying from the RGB image that a new food item may be added to the cooking vessel.

According to an embodiment, a period when the processing circuitry obtains the RGB image through the at least one RGB camera or the thermal image through the at least one thermal imaging camera may be set to be shorter than a period when the processing circuitry measures the estimated time.

According to an embodiment, the processing circuitry may transmit a control command to adjust a heating intensity of a cooktop based on a temperature difference between the temperature and the preset target temperature to the cooktop.

According to an embodiment, the processing circuitry may adjust a rotational speed of a fan based on at least one of the temperature, the RGB image, or the thermal image.

A method for controlling a range hood according to another aspect of the disclosure may comprise obtaining a thermal image through a thermal imaging camera disposed on a rear side, identifying a temperature of an object included in the thermal image, and determining an estimated time required for the temperature of the object to reach a preset target temperature based on a changing trend in the temperature of the object, and displaying the estimated time on a display. The estimated time may be determined after a predetermined time has elapsed from a time the temperature of the object is identified to when a change in the temperature of the object included in the thermal image is detected.

As such, according to various embodiments of the disclosure, the temperature of the food item or cooking vessel over the cooktop may be accurately measured, and the time until the measured temperature reaches a preset target temperature may be predicted.

As a time is predicted, the range hood according to various embodiments of the disclosure may transmit the prediction result to another electronic device capable of wired/wireless communication, such as a cooktop, a wireless terminal, and a display device.

Further, the range hood according to various embodiments of the disclosure may identify a food item without error through an RGB camera although a food item is added during the cooking process, and may again accurately predict the estimated time required for the measurement temperature to reach the target temperature due to changes in food items during the cooking process.

### BRIEF DESCRIPTION OF DRAWINGS

FIG. 1 is a block diagram illustrating a configuration of a range hood according to an embodiment of the disclosure;

FIG. 2 is a perspective view illustrating a range hood according to an embodiment of the disclosure;

FIG. 3 is a cross-sectional view illustrating a range hood according to an embodiment of the disclosure;

FIG. 4 is a perspective view illustrating a sensor module included in an embodiment of the disclosure;

FIG. 5 is a view illustrating mapping of a thermal image and an RGB image according to an embodiment of the disclosure;

FIG. 6 is a view illustrating a temperature graph generated according to an embodiment of the disclosure;

FIG. 7 is a flowchart illustrating a method for controlling a range hood according to various embodiments of the disclosure;

FIG. 8 is a flowchart illustrating a method for controlling a range hood according to various embodiments of the disclosure;

FIG. 9 is a flowchart illustrating a method for controlling a range hood according to various embodiments of the disclosure;

FIG. 10 illustrates an example of an interface screen where a range hood displays an estimated required time according to various embodiments of the disclosure.

FIG. 11 illustrates an example of an interface screen where a range hood allows a wireless device to display an estimated required time according to various embodiments of the disclosure;

FIG. 12 illustrates an example for describing an event in which a range hood starts measuring an estimated required time according to various embodiments of the disclosure;

FIG. 13 is a graph illustrating a temperature change when a range hood adjusts a temperature of a food item or a cooking vessel according to various embodiments of the disclosure;

FIG. 14 is a flowchart illustrating a method for controlling a range hood according to various embodiments of the disclosure;

FIGS. 15 and 16 illustrate an example of a user interface screen of a user terminal according to various embodiments of the disclosure; and

FIG. 17 is a view schematically illustrating a home appliance, a server, or a user device according to various embodiments of the disclosure.

### MODE FOR THE INVENTION

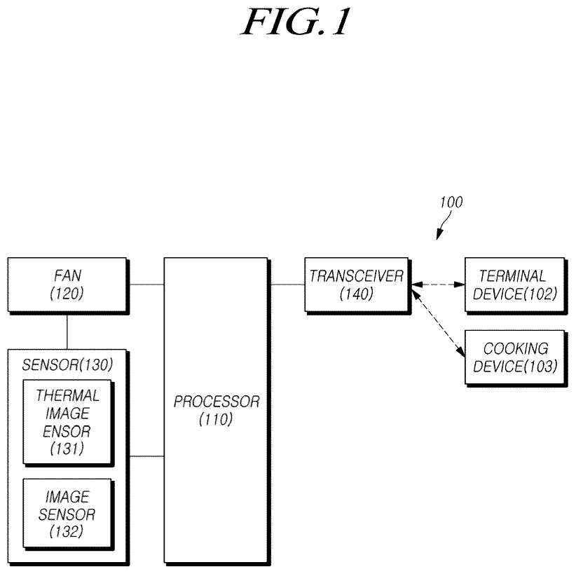

Various embodiments of the disclosure are merely exemplified herein with reference to FIGS. 1 to 17, to describe the principle of the disclosure, and should not be interpreted as limiting the scope of the disclosure. Those skilled in the art will understand that the principle of the disclosure may be implemented in any appropriately disposed system or device.

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

FIG. 1 is a block diagram illustrating a configuration of a range hood according to an embodiment of the disclosure.

In an example, a range hood 100 may include a fan 120. The fan 120 may form an air flow to remove smoke, steam, and other cooking contaminants generated in the kitchen. The fan 120 may form an air flow that sucks smoke, steam, and other gas contaminants generated during cooking from the cooktop to the range hood 100, and the air flow containing gas contaminants may be discharged to the outside. The fan 120 may include various components for forming an air flow. For example, the fan 120 may include a blade and a motor for rotating the blade. Further, the fan 120 may further include a fan control circuitry for controlling the motor. The fan control circuitry may be electrically connected to the motor to control the rotational speed or noise level of the fan 120. The fan control circuitry may be electrically connected to the main processing circuitry of the range hood 100, or may be configured as at least a portion of the main processing circuitry.

In an example, the range hood 100 may include one or more sensors 130. The sensor 130 may include at least one of a thermal image sensor 131 and an image sensor 132. The thermal image sensor 131 and the image sensor 132 may be included individually. The thermal image sensor 131 and the image sensor 132 may be integrally formed.

In an example, the range hood 100 may include a thermal image sensor 131. The object emits infrared radiation (IR radiation) according to its own temperature. The IR radiation is emitted in a larger amount as the temperature of the object increases, and thermal image sensor 131 may detect it in the form of an image generated from the object. Further, the thermal image sensor 131 may be designed to detect a specific wavelength of IR. Since different objects emit different wavelengths, thermal image sensor 131 may detect the object using the detected wavelength.

In an example, the range hood 100 may include an image sensor 132. The image sensor 132 may detect light reflected from an object and generate a color image using the light. The image sensor 132 may include various color filters for distinguishing colors of objects. The color filters may include, e.g., a red color filter, a green color filter, and a blue color filter, but the disclosure is not limited thereto. The image sensor 132 may include a plurality of pixels, and the plurality of pixels may be disposed in a two-dimensional pixel array. Meanwhile, the image sensor 132 applied to various embodiments of the disclosure may be an RGB sensor, but various embodiments of the disclosure are not limited thereto.

Each of thermal image sensor 131 and/or the image sensor 132 of the disclosure may include an electrically connected sensor circuitry. Further, the thermal image sensor 131 and/or the image sensor 132 may be electrically connected to one sensor circuitry. Further, the sensor circuitry may be electrically connected to the main processing circuitry of the range hood 100, or may be included as at least a portion of the main processing circuitry.

In an example, the range hood 100 may include a transceiver 140. The transceiver 140 supports wired or wireless communication between the range hood 100 and other electronic devices. A wireless communication module or an RF module may be included. The wireless communication module may include, for example, Wi-Fi, BT, GPS or NFC. For example, the wireless communication module may provide a wireless communication function using a radio frequency. In an example, the range hood 100 may communicate with another terminal device by the transceiver 140 by wire or wirelessly. In an example, the range hood 100 may wiredly or wirelessly communicate with another cooking device by the transceiver 140.

In an example, the range hood 100 may include a processor 110. The processor 110 may be electrically connected to at least one of a fan 120, one or more sensors 130, or a transceiver 140. The processor 110 may control the electrically connected fan 120, sensor 130, or transceiver 140. In an example, the processor 110 may include a processing circuitry. The processing circuitry may be electrically connected to the transceiver 140. The processing circuitry may be electrically connected to the sensor circuitry or may include the sensor circuitry. The processing circuitry may be electrically connected to the fan control circuitry or may include the fan control circuitry.

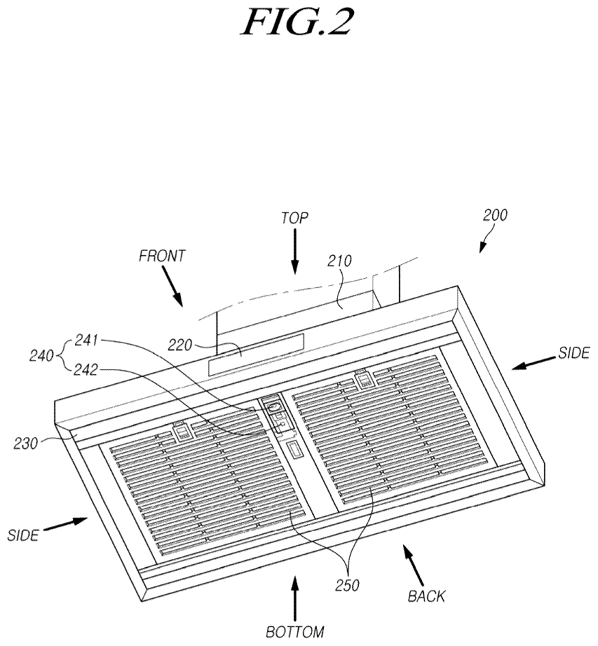

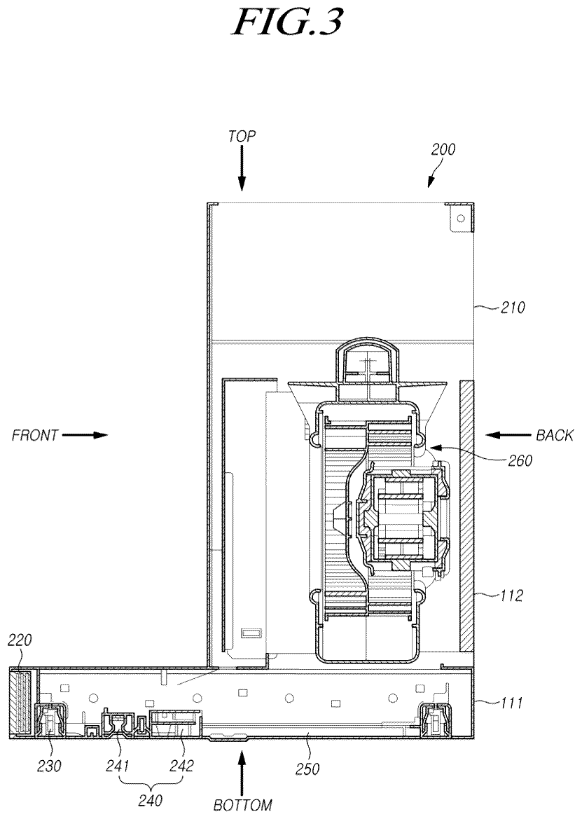

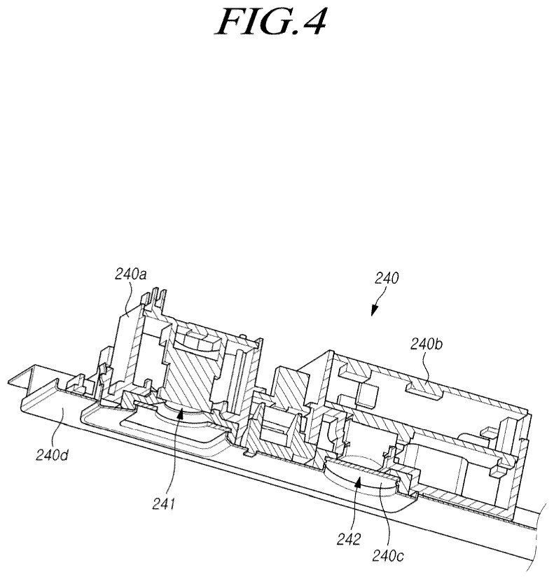

FIG. 2 is a perspective view illustrating a range hood according to an embodiment of the disclosure, and FIG. 3 is a cross-sectional view illustrating a range hood according to an embodiment of the disclosure. Further, FIG. 4 is a perspective view illustrating a sensor module included in an embodiment of the disclosure.

Referring to FIGS. 2 and 3, the range hood 200 may include a housing 210. The housing 210 forms the exterior of the range hood 200. The exterior of the range hood 200 may be specified by the housing 210. Various components of the range hood 200 to be described below may be included in the housing 210. For example, a display 220, a lighting module 230, a sensor module 240, a filter module 250, or a fan 260 may be included inside the housing 210.

The housing 210 may be divided into a front side, a lateral side, a lower side, and an upper side. In the disclosure, a direction facing the cooktop to be positioned under the range hood 200 may be defined as the lower side. Further, the direction in which the user views the range hood 200 may be defined as the front side, and the left and right sides of the front side may be defined as two opposite lateral sides. The range hood 200 may suction external air through the filter module 250 formed on a lower side thereof. The suctioned air may be discharged to the outside through a duct formed on the upper side.

At least one of the filter module 250, the sensor module 240, and/or the lighting module 230 may be disposed on the lower side of the housing 210.

The filter module 250 may include a filter and a filter housing. The filter may remove foreign objects from the passing air by filtration. The filter may at least partially remove contaminants from the passing air, and the removed contaminants may remain in the filter. The filter may include, e.g., a charcoal filter, an aluminum mesh filter, a baffle filter, and a cassette filter, but various embodiments of the disclosure are not limited to any one of them. The filter housing may cover the lower side of the filter module 250, may be physically coupled to the housing 210 of the range hood 200, or may be included as at least a portion of the housing 210 of the range hood 200. The filter housing may include a plurality of holes to attract air suctioned to the filter. The hole may be formed in various shapes such as a round shape, a rod shape, and an ellipse shape, and various embodiments of the disclosure are not limited to any one of them.

The range hood 200 may include a display 220. The display 220 may be disposed in a front direction of the housing 210 of the range hood 200. The display 220 may display various information related to the current state or control operation of the range hood 200. The display 220 may display various information, such as, e.g., the temperature of the food item or cooking vessel disposed over the cooktop, the estimated time required to reach the target time, and the current state of the food item. Various pieces of information displayed on the display 220 may be provided to the display 220 by the processing circuitry.

Referring to FIGS. 2, 3 and 4, the sensor module 240 may include an image sensor 241 or a thermal image sensor 242 and a sensor housing 240a.

The sensor may include, e.g., at least one of the image sensor 241 and the thermal image sensor 242. The image sensor 241 may be included in the imaging camera. The thermal image sensor 242 may be included in a thermal imaging camera. The imaging camera may be, e.g., an RGB camera. Here, the image sensor 241 and thermal image sensor 242 may be disposed adjacent to each other. The image sensor 241 and thermal image sensor 242 may be disposed to be spaced apart from each other. The image sensor 241 and thermal image sensor 242 may be disposed in a line, and the image sensor 241 may be disposed closer to the front side of the range hood 200 than the thermal image sensor 242. Accordingly, since the gas contaminant from the cooktop approaches the thermal image sensor 242 more than the image sensor 241, the image sensor 241 may be less affected by the gas contaminant.

The image sensor 241 or thermal image sensor 242 may be mounted on the sensor housing 240a. The image sensor 241 or thermal image sensor 242 mounted on the sensor housing 240a may be electrically connected to the sensor circuitry 240b.

The sensor module 240 may be disposed to face the lower side of the range hood 200, and may include a protective window 240c for protecting the sensor from the outside. Here, the protective window 240c may include a transparent material so that light directed to the sensor is not blocked.

The sensor module 240 may include a sensor circuitry 240b electrically connected to the image sensor 241 or thermal image sensor 242. The sensor circuitry 240b may be formed on the printed circuit board. The sensor circuit board may be disposed within a receiving space of the sensor housing 240a.

The sensor housing 240a may include a sensor holder (not illustrated). The sensor holder may be formed to fill the remaining space except for the sensor and the sensor circuitry 240b. The sensor holder is in physical contact with the sensors 241 and 242, the sensor circuitry 240b, and the protective window 240c constituting the sensor module 240, and may be fixed so that the above-described components do not move.

The sensor module 240 may include a sensor cover 240d. The sensor cover 240d may function as a protective wall for protecting a lower direction of the sensor module 240. The sensor cover 240d may include an opening in the lower direction, and the protective window 240c may be disposed in each opening.

Referring back to FIGS. 2 and 3, the lighting module 230 may be disposed on the front side of the range hood 200 to irradiate light toward the cooktop. The lighting module 230 may be disposed in a straight line on the front side of the range hood 200, but is not limited thereto, and a plurality of lighting modules 230 may be disposed to be spaced apart from each other. The lighting module 230 may be disposed closer to the front side of the range hood 200 than the sensor module 240 described above. The lighting module 230 may be disposed closest to the front side among the components disposed on the rear side except for the display 220 of the range hood 200.

Referring to FIG. 3, the range hood 200 may include a fan 260. As described above with reference to FIG. 1, the fan 260 may generate an air flow. As the air flow is generated, air including contaminants may be suctioned from the outside to the inside of the range hood 200. The suctioned air may be discharged to the outside through a duct inside the range hood 200.

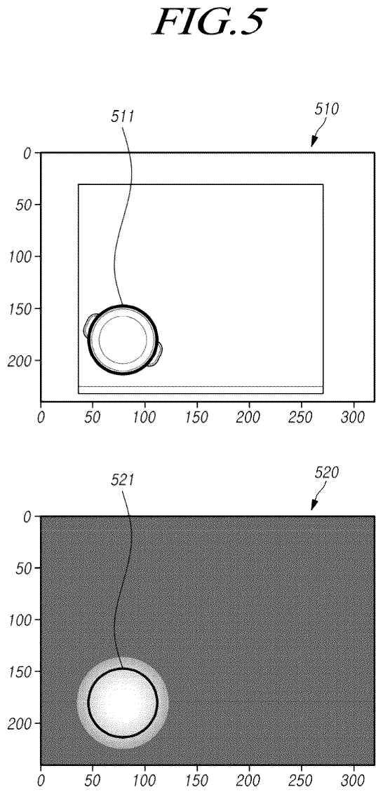

FIG. 5 is a view illustrating mapping of a thermal image and an RGB image according to an embodiment of the disclosure.

The example range hood described above with reference to FIGS. 1 to 4 may obtain various images using various sensors. For example, the range hood may obtain an RGB image 510 using an image sensor (e.g., the image sensor 241 of FIG. 2) and obtain a thermal image 520 using a thermal image sensor (e.g., the thermal image sensor 242 of FIG. 2). Since the thermal image 520 and the RGB image 510 are obtained from different sensors, they may be generated at different wide angles. In other words, the RGB image 510 and thermal image 520 may be partially different from each other.

The processor applied to an example embodiment of the disclosure may detect the temperature and/or a temperature change in the cooking vessel or food item over the cooktop using the RGB image 510 and thermal image 520. The RGB image 510 may include the position and shape of the cooking vessel or food item positioned over the cooktop as similar to the actual one, and the thermal image 520 may include the temperature of the cooking vessel or food item positioned over the cooktop. Accordingly, the processor may identify the position and/or shape of the food item using the RGB image 510, and may identify the temperature at the identified position and/or shape using thermal image 520. In other words, the processor may set a first region of interest (ROI) 511 using the RGB image 510, and set a second ROI 521 on the thermal image 520 based on the first ROI 511 in the RGB image 510.

In an example, the processor may associate the RGB image 510 with the thermal image 520 using at least one of feature-based matching, homography, optical flow, or stereo calibration. For example, the processor may map the RGB image 510 and thermal image 520 by estimating the homography matrix. Accordingly, the first ROI 511 related to the RGB image 510 may be substantially mapped to the second ROI 521 related to the thermal image 520.

The processor may detect the temperature and/or a temperature change in the second ROI 521 by detecting the temperature based on the second ROI 521 of the thermal image 520. The processor may improve the accuracy of temperature detection by detecting the temperature in a partial area (i.e., the second ROI 521) rather than the entire area of the thermal image 520. Further, as the processor processes the thermal image 520 obtained in the second ROI 521 rather than the entire area of the thermal image 520, the processing power of the processor may be concentrated, allowing for a more efficient and accurate system design. Further, a plurality of second ROIs 521 may be provided, and the processor may individually monitor each of the plurality of second ROIs 521.

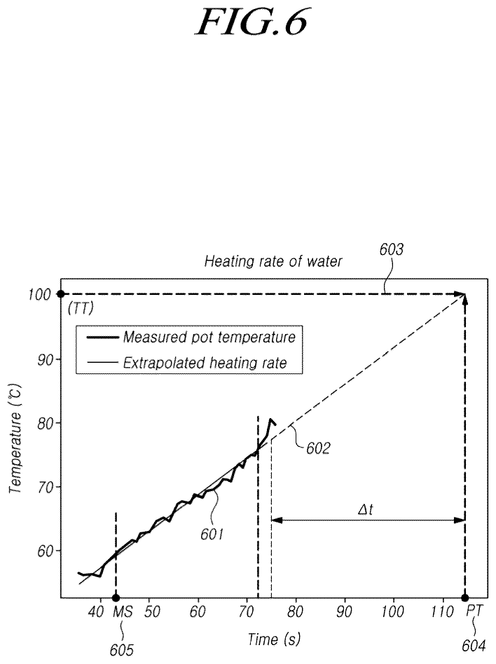

The processor applied to an example embodiment of the disclosure may detect a temperature change in the second ROI 521. Further, the processor may generate a temperature graph based on the temperature change in the second ROI 521. Hereinafter, the temperature graph generated by the processor is exemplarily illustrated with reference to FIG. 6. Further, a time monitoring method to assist cooking on a cooktop is exemplarily described using a temperature graph.

FIG. 6 is a view illustrating a temperature graph generated according to an embodiment of the disclosure.

Referring to FIG. 6, the range hood according to an example embodiment may generate a temperature graph through the processor. The temperature graph may include a current temperature 601 and a temperature trend 602. The temperature trend 602 may be generated in a straight line, but is not limited thereto and may be generated in a curved shape.

The temperature graph may be generated using an RGB image and a thermal image. The RGB image may be a basis for determining the first ROI corresponding to the shape of the cooking vessel or food item positioned over the cooktop. The thermal image may be a basis for detecting the temperature 601 of the cooking vessel or food item positioned over the cooktop.

The second ROI may be set in the thermal image based on the position information about the first ROI associated with the RGB image. Thermal image and RGB image are disposed to overlap at substantially the same position or, unless they are generated by a single camera, are generated based on different wide angles. Accordingly, the processor may set position information about the first ROI associated with the RGB image as the second ROI associated with the thermal image.

The processor may measure the temperature in the second ROI or identify a temperature change.

In an example, the processor may determine an expected time (t) (estimated required time) until the current temperature 601 reaches a preset target temperature TT in response to the identification of the temperature change. For example, the processor may determine at least continuously or periodically the estimated time (t) required for the current temperature 601 to reach the preset target temperature TT after the cooktop starts the heating operation or in response to detecting a temperature change in the food item or cooking vessel. For example, the processor may determine at least continuously or periodically the estimated time t required for the current temperature 601 to reach the preset target temperature TT in response to the elapse of a predetermined period of time (e.g., MS, 605) from the time when a temperature change in the food item or cooking vessel is detected.

In an example, the processor may start a temperature measurement to determine the estimated required time t based on identifying a temperature change. A temperature trend 602 may be used to determine the estimated required time t. The temperature trend 602 may be obtained through a temperature value that changes over time. In order to generate an accurate temperature trend 602, it is necessary to remove unnecessary noise. Thus, a predetermined period of time has passed (e.g., time 605) after a temperature change is identified, rather than at the time when the temperature change is identified, the processor may start measuring the temperature to determine the estimated required time t, thereby enhancing the accuracy of the temperature trend 602.

The processor may periodically or continuously measure the estimated required time t, and may display the measurement result on the display. Further, the processor may transmit the measurement result to another electronic device. The processor may also measure the estimated arrival time PT, 604 reflecting the estimated required time t together with the estimated required time t. The estimated arrival time PT, 604 may be displayed on the display together with the estimated required time t or may be transmitted to another electronic device.

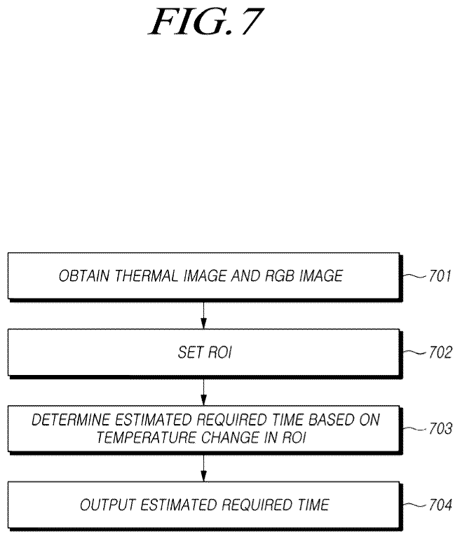

FIG. 7 is a flowchart illustrating a method for controlling a range hood according to various embodiments of the disclosure.

Each operation of FIG. 7 may be operated by a range hood according to various embodiments of the disclosure. The range hood may correspond to the range hood described above with reference to FIGS. 1 to 4.

In operation 701, the range hood may obtain at least one of a thermal image or an RGB image. For example, the range hood may obtain a thermal image through a thermal imaging camera. For example, the range hood may obtain an RGB image through an RGB camera. The thermal imaging camera may include a thermal image sensor. The RGB camera may include an image sensor or an RGB sensor.

In operation 702, the range hood may set a region of interest (ROI) on at least one of the thermal image or the RGB image. The ROI may be set for each of the thermal image and the RGB image. In an example, the range hood may set a ROI based on a temperature difference in the thermal image. In an example, the range hood may identify the first ROI based on the object shape identified in the RGB image, and set the second ROI mapped to the first ROI in the thermal image. The first ROI and the second ROI may be substantially the same, but are not limited thereto, and there may be differences in position coordinates. Such a difference is due to the difference in the installed positions of the RGB camera and thermal camera, and the processor may compensate for the position difference between the RGB camera and thermal camera to map the first ROI and the second ROI.

In operation 703, the range hood may measure a temperature change in at least one of the food item or the cooking vessel in the region of interest to determine an estimated time required to reach a preset target temperature. For example, the range hood may measure the temperature based on the region of interest set in the thermal image or the second region of interest set in the thermal image based on the RGB image. Temperature may be measured periodically or continuously over time, and may form a trend if sufficient time is given. The range hood may determine an additional estimated time required to reach the target temperature based on the temperature trend.

In operation 704, the range hood may display a user interface representation including an estimated required time on the display. Alternatively, the range hood may transmit an information element for displaying the estimated required time to the wireless device. The wireless device receiving the information element may display the user interface representation including the estimated required time on the display.

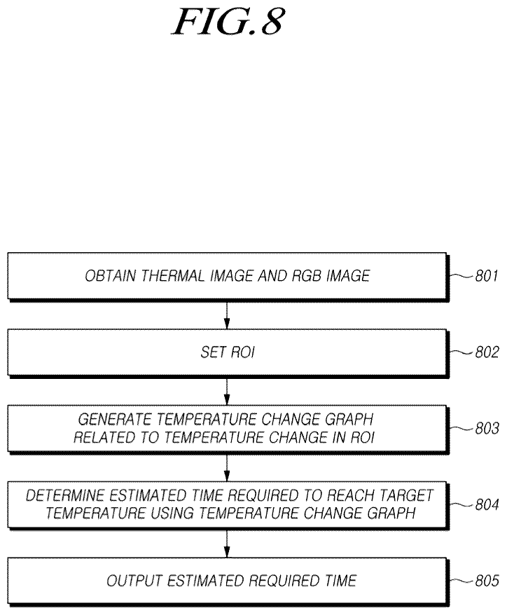

FIG. 8 is a flowchart illustrating a method for controlling a range hood according to various embodiments of the disclosure.

Each operation of FIG. 8 may be operated by a range hood according to various embodiments of the disclosure. The range hood may correspond to the range hood described above with reference to FIGS. 1 to 4.

In operation 801, the range hood may obtain at least one of a thermal image or an RGB image. For example, the range hood may obtain a thermal image through a thermal imaging camera. For example, the range hood may obtain an RGB image through an RGB camera. The thermal imaging camera may include a thermal image sensor. The RGB camera may include an image sensor or an RGB sensor.

In operation 802, the range hood may set a region of interest (ROI) on at least one of the thermal image or the RGB image. The ROI may be set for each of the thermal image and the RGB image. In an example, the range hood may set a ROI based on a temperature difference in the thermal image. In an example, the range hood may identify the first ROI based on the object shape identified in the RGB image, and set the second ROI mapped to the first ROI in the thermal image. The first ROI and the second ROI may be substantially the same, but are not limited thereto, and there may be differences in position coordinates. Such a difference is due to the difference in the installed positions of the RGB camera and thermal camera, and the processor may compensate for the position difference between the RGB camera and thermal camera to map the first ROI and the second ROI.

In operation 803, the range hood may measure a temperature change in at least one of the food item or the cooking vessel in the region of interest to generate a temperature change graph. The temperature change graph may include a measured temperature and a temperature trend. The measured temperature is a temperature measured from the region of interest of the thermal image, and the temperature trend may include a predicted value calculated based on the temperature change. A detailed description of the temperature change graph is substantially the same as that described above with reference to FIG. 6.

In operation 804, the range hood may determine an estimated time required to reach the target temperature based on the temperature change graph. The estimated time required to reach the target temperature branch may be determined using the temperature trend. The temperature trend may extend along the trend direction, and at least one point of the temperature trend may coincide with the target temperature. As at least one point of the temperature trend, a time value of the coordinates matching the target temperature may be an expected arrival time to reach the target temperature. The estimated required time may be calculated as the difference between the current time and the estimated arrival time.

In operation 805, the range hood may display the user interface representation including an estimated required time on the display. Alternatively, the range hood may transmit an information element for displaying the estimated required time to the wireless device. The wireless device receiving the information element may display the user interface representation including an estimated required time on the display.

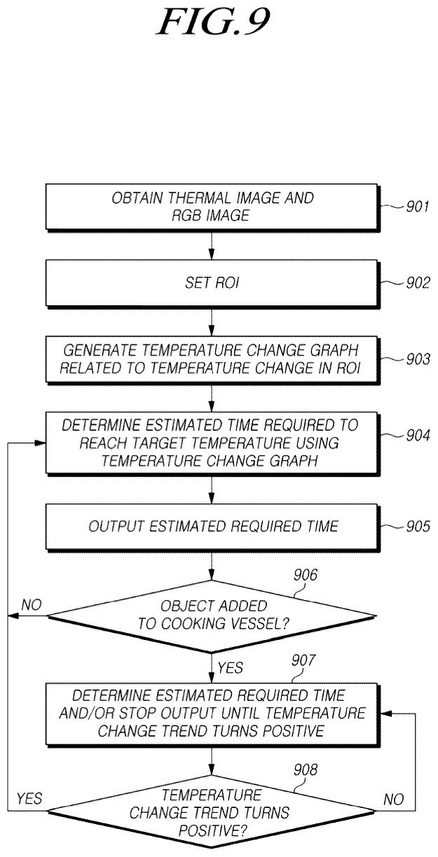

FIG. 9 is a flowchart illustrating a method for controlling a range hood according to various embodiments of the disclosure.

Each operation of FIG. 9 may be operated by a range hood according to various embodiments of the disclosure. The range hood may correspond to the range hood described above with reference to FIGS. 1 to 4.

In operation 901, the range hood may obtain at least one of a thermal image or an RGB image. For example, the range hood may obtain a thermal image through a thermal imaging camera. For example, the range hood may obtain an RGB image through an RGB camera. The thermal imaging camera may include a thermal image sensor. The RGB camera may include an image sensor or an RGB sensor.

In operation 902, the range hood may set a region of interest (ROI) on at least one of the thermal image or the RGB image. The ROI may be set for each of the thermal image and the RGB image. In an example, the range hood may set a ROI based on a temperature difference in the thermal image. In an example, the range hood may identify the first ROI based on the object shape identified in the RGB image, and set the second ROI mapped to the first ROI in the thermal image. The first ROI and the second ROI may be substantially the same, but are not limited thereto, and there may be differences in position coordinates. Such a difference is due to the difference in the installed positions of the RGB camera and thermal camera, and the processor may compensate for the position difference between the RGB camera and thermal camera to map the first ROI and the second ROI.

In operation 903, the range hood may measure a temperature change in at least one of the food item or the cooking vessel in the region of interest to generate a temperature change graph. The temperature change graph may include a measured temperature and a temperature trend. The measured temperature is a temperature measured from the region of interest of the thermal image, and the temperature trend may include a predicted value calculated based on the temperature change. A detailed description of the temperature change graph is substantially the same as that described above with reference to FIG. 6.

In operation 904, the range hood may determine an estimated time required to reach the target temperature based on the temperature change graph. The estimated time required to reach the target temperature branch may be determined using the temperature trend. The temperature trend may extend along the trend direction, and at least one point of the temperature trend may coincide with the target temperature. As at least one point of the temperature trend, a time value of the coordinates matching the target temperature may be an expected arrival time to reach the target temperature. The estimated required time may be calculated as the difference between the current time and the estimated arrival time.

In operation 905, the range hood may display the user interface representation including an estimated required time on the display. Alternatively, the range hood may transmit an information element for displaying the estimated required time to the wireless device. The wireless device receiving the information element may display the user interface representation including an estimated required time on the display.

In operation 906, the range hood may detect that a new object (e.g., a new food item) is added to the cooking vessel. However, the disclosure is not limited thereto, and the range hood may detect a decrease in the amount of objects in the cooking vessel or a change of the cooking vessel. This is because the range hood may detect changes such as addition, reduction, and change of objects based on RGB images. When the amount of food items is changed, the food item itself is changed, or the cooking vessel is changed, the estimated required time determined in the previous operation 904 may lose reliability. Accordingly, the range hood may perform operation 907 if a new event, such as adding a new food item, reduction in the amount of the existing food items, or change of the cooking vessel, is detected based on object detection on the RGB image, and if not, periodically or continuously perform any one of operation 901 to operation 905.

In operation 907, the range hood may identify the temperature change after the new event occurs, determine the estimated required time until the trend of the temperature change turns positive, and/or stop the output (or display) of the estimated required time.

In operation 908, the range hood may wait until the temperature trend after the new event is detected has the same direction as before (e.g., positive direction or negative direction) and, if the temperature trend has the same direction as before, perform any one of operation 901 to operation 905. However, if not, the range hood may maintain the state of operation 907.

Meanwhile, according to various embodiments, the estimated required time may be divided into a first estimated required time and a second estimated required time according to time points. The first estimated required time may be an estimated required time measured at a first time point, and the second estimated required time may be an estimated required time measured at a second time point. The second time point may be later than the first time point. The interval between the first time point and the second time point may be set to be constant. In other words, the estimated required time may be measured periodically by using an interval between the first time point and the second time point as a period.

The estimated required time may include a third estimated required time as well as the first estimated required time and the second estimated required time. The third estimated required time may be measured when a new event such as operation 906 is detected. For example, the third estimated required time may be determined to be measured based on identifying from the RGB image that a new food item is added to the cooking vessel. Since the third estimated required time is determined to be measured in response to a new event occurring irregularly, unlike the first estimated required time or the second estimated required time, the third time point when the third estimated time is measured may be between the first time point and the second time point. In other words, the third time may be measured between measurement periods of regular estimated required times (first and second estimated required times).

Further, according to various embodiments, the period of obtaining an image through at least one of the thermal imaging camera or the RGB camera may be set to be shorter than the period in which the processor of the range hood measures a regular estimated required time (first or second estimated required time). In this case, a new event such as operation 906 may be effectively detected by obtaining a thermal image or an RGB image in a shorter period.

Meanwhile, although not limited thereto, the range hood of the disclosure may automatically adjust the rotational speed of the fan. For example, the rotational speed of the fan may be adjusted based on at least one of temperature, RGB image, or thermal image. As the measured temperature increases, it may increase the rotational speed of the fan and, as the temperature decreases, it may decrease the rotational speed of the fan. In this case, not only the temperature but also the type of food item or cooking vessel detected through the RGB image may be considered in determining the rotational speed.

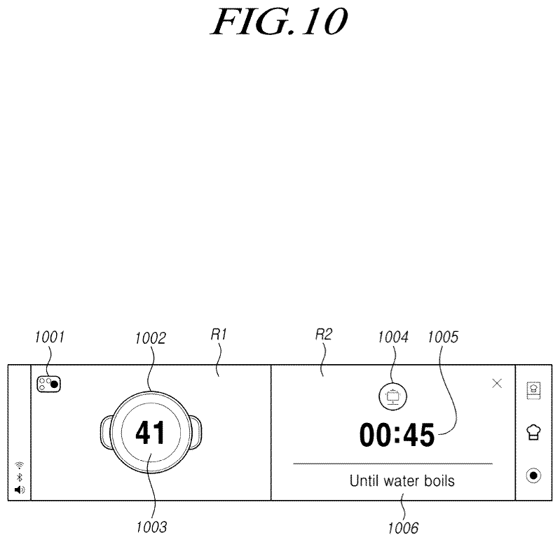

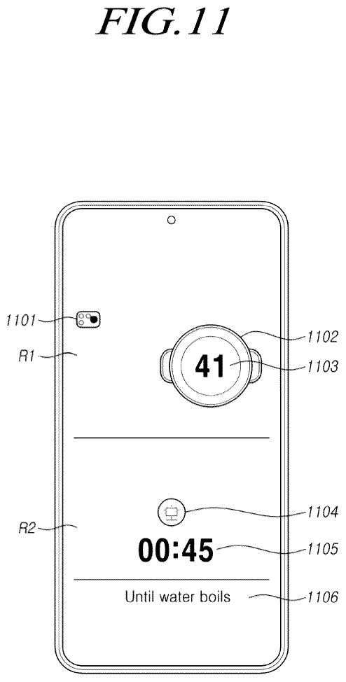

FIG. 10 illustrates an example of an interface screen where a range hood displays an estimated required time according to various embodiments of the disclosure. FIG. 11 illustrates an example of an interface screen where a range hood allows a wireless device to display an estimated required time according to various embodiments of the disclosure.

Referring to FIGS. 10 and 11, the interface screen is divided into a first area R1 and a second area R2. The first area R1 may include at least one of cooktop position icons 1001 and 1101, cooking vessel icons 1002 and 1102, or temperature indications 1003 and 1103. The second area R2 may include at least one of estimated required times 1005 and 1105, cooking operation icons 1004 and 1104, or cooking operation descriptions 1006 and 1106.

The cooktop position icons 1001 and 1101 are graphic icons for displaying the positions of heat sources of the cooktop. The cooktop position icons 1001 and 1101 may abstractly represent the positions of the heat sources of the cooktop, and among the heat sources, heat sources associated with the estimated required times 1005 and 1105 currently displayed may be represented in different colors or shades.

The cooking vessel icons 1002 and 1102 are graphic icons representing cooking vessels associated with the estimated required times 1005 and 1105 currently displayed. The cooking vessel icons 1002 and 1102 may be associated with or substantially the same as the shape of the cooking vessel identified by the RGB image.

The temperature indications 1003 and 1103 are graphic icons that display the currently measured temperature of the food item or cooking vessel measured using the thermal image, or the thermal image and the RGB image. The temperature indications 1003 and 1103 may be displayed to overlap the cooking vessel icons 1002 and 1102. The temperature indications 1003 and 1103 may be displayed adjacent to the cooking vessel icons 1002 and 1102.

The estimated required times 1005 and 1105 are graphic icons displaying the estimated required times 1005 and 1105 described above with reference to FIGS. 5 to 9. Cooking operation icons 1004 and 1104 may be displayed adjacent to the estimated required times 1005 and 1105. The cooking operation icons 1004 and 1104 may be represented as icons corresponding to various cooking operations such as boiling, frying, and roasting. The cooking operation descriptions 1006 and 1106 may be composed of short sentences describing the cooking operations. The cooking operation descriptions 1006 and 1106 may include a food item (e.g., water) and a cooking operation (e.g., boiling), but the disclosure is not limited thereto. The food item and/or cooking operation may be identified by RGB image.

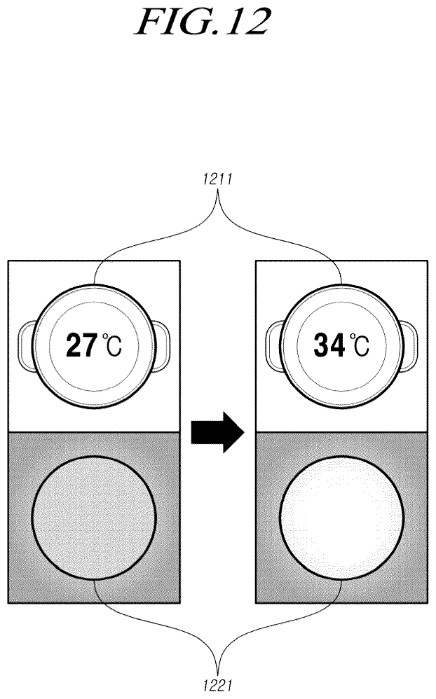

FIG. 12 illustrates an example for describing an event in which a range hood starts measuring an estimated required time according to various embodiments of the disclosure.

In an example, the range hood may generate a temperature trend after a predetermined time elapses from the time when the temperature change is measured. The temperature trend may have higher accuracy when generated a predetermined period of time after the time when the temperature change is detected, rather than when generated in response to detecting the temperature change. When a temperature change is first detected, the temperature change may be large or may not have a constant trend but, if a temperature trend is generated after a predetermined period of time, such noise may be excluded from the trend generation process.

The temperature change may be detected using the RGB image and the thermal image, as described above with reference to FIG. 5. For example, the range hood may determine the first ROI through the RGB image, and may use the first ROI 1211 to determine the second ROI 1221 to be applied to thermal image. Thereafter, the range hood may detect a temperature change in the second ROI 1221.

As illustrated in FIG. 12, it may be identified that the color of thermal image is changed and the measured temperature is changed from 27 degrees to 34 degrees. As such, when a predetermined period of time elapses from the time when the temperature change is detected, the range hood may start generating a temperature trend, and the temperature until a predetermined period of time elapses may be excluded from the generation of the temperature trend.

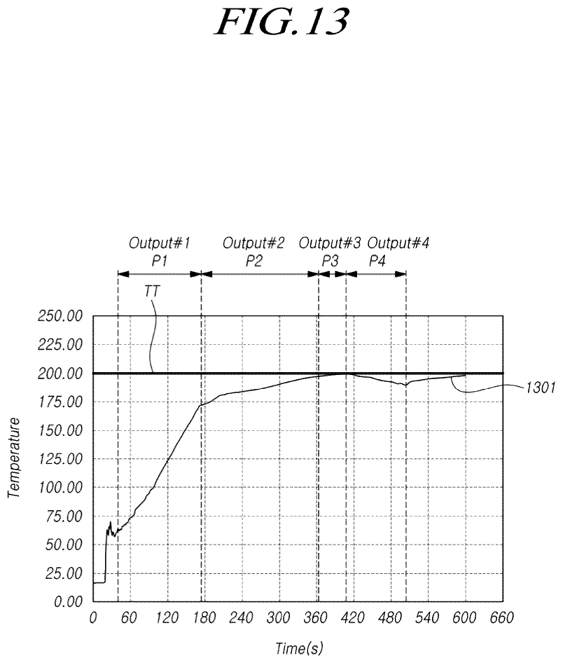

FIG. 13 is a graph illustrating a temperature change when a range hood adjusts a temperature of a food item or a cooking vessel according to various embodiments of the disclosure.

Referring to FIG. 13, the range hood may adjust the heating intensity of the cooktop in conjunction with the wirelessly connected cooktop. The range hood may adjust the heating intensity of the cooktop by transmitting a control command directly to the cooktop. The range hood may guide the user to adjust the heating intensity of the cooktop by transmitting a message requesting control of the cooktop to the user terminal.

The range hood may adjust the output intensity of the cooktop based on the difference between the current temperature 1301 measured for the food item or the cooking vessel and the preset target temperature TT. The output intensity of the cooktop may be set to be larger as the difference between the target temperature TT and the current temperature 1301 increases. For example, in period P1, the range hood may control the cooktop at output #1, in period P2, the range hood may control the cooktop at output #2, in period P3, the range hood may control the cooktop at output #3, and in period P4, the range hood may control the cooktop at output #4. Since the difference between the current temperature 1301 and the target temperature TT is the largest in period P1, the range hood may control the cooktop at a strong heating intensity. Since the current temperature 1301 and the target temperature TT are close to each other in period P3, the range hood may control the cooktop at a relatively weak heating intensity. Thereafter, as the current temperature 1301 falls below the target temperature TT again in period P4, the range hood may control the cooktop again at a relatively strong heating intensity.

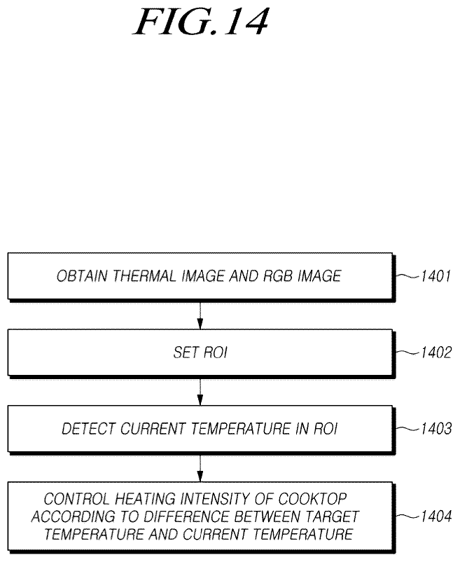

FIG. 14 is a flowchart illustrating a method for controlling a range hood according to various embodiments of the disclosure.

Each operation of FIG. 14 may be operated by a range hood according to various embodiments of the disclosure. The range hood may correspond to the range hood described above with reference to FIGS. 1 to 4.

In operation 1401, the range hood may obtain at least one of a thermal image or an RGB image. For example, the range hood may obtain a thermal image through a thermal imaging camera. For example, the range hood may obtain an RGB image through an RGB camera. The thermal imaging camera may include a thermal image sensor. The RGB camera may include an image sensor or an RGB sensor.

In operation 1402, the range hood may set a region of interest (ROI) on at least one of the thermal image or the RGB image. The ROI may be set for each of the thermal image and the RGB image. In an example, the range hood may set a ROI based on a temperature difference in the thermal image. In an example, the range hood may identify the first ROI based on the object shape identified in the RGB image, and set the second ROI mapped to the first ROI in the thermal image. The first ROI and the second ROI may be substantially the same, but are not limited thereto, and there may be differences in position coordinates. Such a difference is due to the difference in the installed positions of the RGB camera and thermal camera, and the processor may compensate for the position difference between the RGB camera and thermal camera to map the first ROI and the second ROI.

In operation 1403, the range hood may detect the temperature or a temperature change in at least one of the food item or the cooking vessel in the region of interest. The temperature of either the food item or the cooking vessel measured in the region of interest may be referred to as a current temperature. In contrast, the preset temperature targeted for the food item or cooking vessel may be referred to as a target temperature.

In operation 1404, the range hood may adjust the heating intensity of the cooktop according to the difference between the target temperature and the current temperature. For example, the range hood may control the cooktop at a stronger temperature intensity as the difference between the target temperature and the current temperature increases. For example, the range hood may control the cooktop at a weaker temperature intensity as the difference between the target temperature and the current temperature decreases. In this case, the range hood may transmit a control command for adjusting the heating intensity of the cooktop based on the temperature difference between the current temperature and the target temperature to the cooktop. However, the disclosure is not limited thereto, and a guide message for adjusting the heating intensity of the cooktop may be transmitted to the user terminal. The user may identify the guide message received by the user terminal, directly adjust the temperature intensity of the cooktop, or transmit a command for controlling the cooktop through the user terminal.

Hereinafter, a user interface screen for controlling the cooktop through the user terminal is exemplarily described.

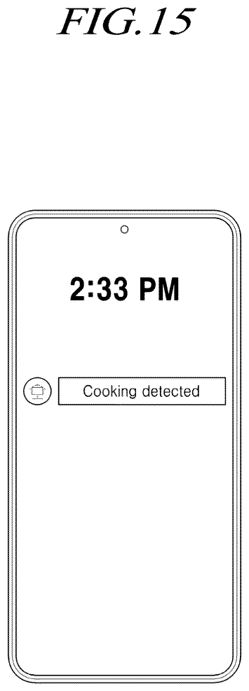

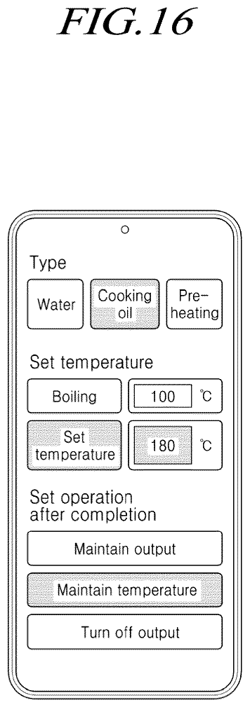

FIGS. 15 and 16 illustrate an example of a user interface screen of a user terminal according to various embodiments of the disclosure.

Referring to FIG. 15, the user interface screen may receive a message indicating that a temperature change has been detected on the unlock screen. The message may include a sentence, such as “Cooking detected.” The unlock screen refers to an interface screen in a state of having not been unlocked through the user ID (e.g., bio ID, password). Upon receiving a message indicating that a temperature change has been detected on the unlock screen, the user terminal may enter the application screen associated with the cooktop or range hood in response to receiving a touch input for the message.

FIG. 16 illustrates an example of an application screen associated with a range hood. Since the range hood according to various embodiments of the disclosure may serve as an IoT device capable of controlling the cooktop, the application screen is described as regarding a range hood, but various embodiments of the disclosure are not limited thereto. In other words, the application screen illustrated in FIG. 16 may be an application screen associated with the cooktop.

Referring to FIG. 16, the application screen may include option(s) for selecting the type of the food item to be cooked. The type of food item may include, e.g., water, cooking oil, or preheating.

The application screen may include an item (e.g., a temperature setting) for setting a target temperature. Through the temperature setting item, the user terminal may set a cooking operation (e.g., boiling, simmering, or frying) and a target temperature (e.g., 100 degrees, 180 degrees, etc.).

Further, the application screen may include items (e.g., setting an operation after completion) for subsequent operations after reaching the target temperature. Items for subsequent operations may include maintaining the output, maintaining the temperature, or turning off the output.

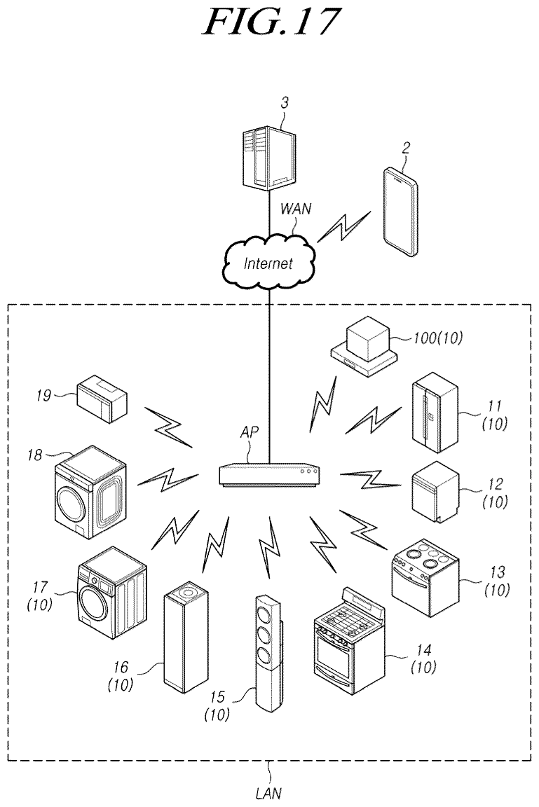

FIG. 17 is a view schematically illustrating a home appliance, a server, or a user device according to various embodiments of the disclosure.

The home appliance 10 may include another home appliance, a communication module capable of communicating with a user device 2 or a server 3, a user interface for receiving a user input or outputting information to the user, at least one processor for controlling the operation of the home appliance 10, and at least one memory storing a program for controlling the operation of the home appliance 10.

The home appliance 10 may be at least one of various types of home appliances. For example, as illustrated, the home appliance 10 may be at least one of a range hood 100, a refrigerator 11, a dishwasher 12, an electric range 13, an electric oven 14, an air conditioner 15, a steam closet 16, a washing machine 17, a dryer 18, and a microwave oven 19, but is not limited thereto. For example, the home appliance 10 may include various types of home appliances such as a robot vacuum, a vacuum cleaner, and a television, which are not illustrated in the drawings. Further, the aforementioned home appliances are merely examples, and in addition to the aforementioned home appliances, a device that is connected to another home appliance, the user device 2, or the server 3 and may perform the operations described below may be included in the home appliance 10 according to an embodiment.

The server 3 may include a communication module capable of communicating with another server, home appliance 10 or the user device 2, at least one processor capable of processing data received from the other server, home appliance 10, or user device 2, and at least one memory capable of storing a program for processing data or processed data. The server 3 may be implemented as various computing devices such as a workstation, a cloud, a data drive, and a data station. The server 3 may be implemented as one or more servers physically or logically divided based on functions, detailed configurations of functions, data, or the like, and may transmit and receive data and process the transmitted and received data through communication between the servers.

The server 3 may manage the user account, register the home appliance 10 by associating the home appliance 10 with the user account, and manage or control the registered home appliance 10. For example, the user may access the server 3 through the user device 2 to create a user account. The user account may be identified by an ID and a password set by the user. The server 3 may register the home appliance 10 in the user account according to a predetermined procedure. For example, the server 3 may register, manage, and control the home appliance 10 by connecting identification information (e.g., a serial number or a MAC address) about the home appliance 10 to the user account. The user device 2 may include a communication module capable of communicating with the home appliance 10 or the server 3, a user interface for receiving a user input or outputting information to the user, at least one processor for controlling the operation of the user device 2, and at least one memory storing a program for controlling the operation of the user device 2.

The user device 2 may be carried by the user or may be disposed in the user's home or office. The user device 2 may include, but is not limited to, a personal computer, a terminal, a mobile phone, a smart phone, a handheld device, a wearable device, or the like.

A program for controlling the home appliance 10, i.e., an application, may be stored in the memory of the user device 2. The application may be sold while being installed on the user device 2, or may be downloaded from an external server and installed.

The user may access the server 3 to create a user account by executing the application installed on the user device 2, and may communicate with the server 3 based on the logged-in user account to register the home appliance 10.

For example, when the home appliance 10 is manipulated so that the home appliance 10 may be connected to the server 3 according to the procedure guided by the application installed on the user device 2, the server 3 may register the home appliance 10 in the user account by registering the identification information (e.g., serial number or MAC address) about the home appliance 10 in the corresponding user account.

The user may control the home appliance 10 using the application installed on the user device 2. For example, when the user logs in to the user account with the application installed on the user device 2, the home appliance 10 registered in the user account appears, and when a control command for the home appliance 10 is input, the control command may be transferred to the home appliance 10 through the server 3.

The network may include both a wired network and a wireless network. The wired network may include a cable network, a telephone network, or the like, and the wireless network may include all networks that transmit and receive signals through radio waves. The wired network and the wireless network may be connected to each other.

The network may include a wide area network (WAN) such as the Internet, a local area network (LAN) formed around an access point (AP), and a short-range wireless network that does not pass through the AP. The short-range wireless network may include, but is not limited to, Bluetooth (IEEE 802.15.1), Zigbee (IEEE 802.15.4), Wi-Fi Direct, near field communication (NFC), and Z-wave.

The AP may connect the home appliance 10 or the user device 2 to a WAN to which the server 3 is connected. The home appliance 10 or the user device 2 may be connected to the server 3 through a WAN.

The AP may communicate with the home appliance 10 or the user device 2 using wireless communication such as Wi-Fi (Wi-Fi, IEEE 802.11), Bluetooth (Bluetooth, IEEE 802.15.1), Zigbee (IEEE 802.15.4), or the like, and may access the wide area network (WAN) using wired communication, but is not limited thereto.

According to various embodiments, the home appliance 10 may be directly connected to the user device 2 or the server 3 without passing through the AP.

The home appliance 10 may be connected to the user device 2 or the server 3 through a long-range wireless network or a short-range wireless network.

For example, the home appliance 10 may be connected to the user device 2 through a short-range wireless network (e.g., Wi-Fi direct).

As another example, the home appliance 10 may be connected to the user device 2 or the server 3 through a wide area network (WAN) using a long-range wireless network (e.g., a cellular communication module).

As another example, the home appliance 10 may access a wide area network (WAN) using wired communication and may be connected to the user device 2 or the server 3 through the wide area network (WAN).

When the home appliance 10 is able to access the wide area network (WAN) using wired communication, it may operate as an access repeater. Accordingly, the home appliance 10 may connect another home appliance to the wide area network (WAN) to which the server 3 is connected. Further, the other home appliance may connect the home appliance 10 to the wide area network (WAN) to which the server 3 is connected.

The home appliance 10 may transmit information about the operation or the status to the other home appliance, the user device 2, or the server 3 through the network. For example, when the request is received from the server 3, when the specific event occurs in the home appliance 10, or periodically or in real time, the home appliance 10 may transmit information about the operation or the status to the other home appliance, the user device 2, or the server 3. When the information about the operation or the status is received from the home appliance 10, the server 3 may update the stored information about the operation or the status of the home appliance 10, and transmit the updated information about the operation and the status of the home appliance 10 to the user device 2 through the network. Here, updating information may include various operations for changing existing information, such as adding new information to existing information and replacing existing information with new information.

The home appliance 10 may obtain various information from the other home appliance, the user device 2, or the server 3, and provide the obtained information to the user. For example, the home appliance 10 may obtain information related to the function of the home appliance 10 (e.g., recipe, washing method, etc.) and various environmental information (e.g., weather, temperature, humidity, etc.) from the server 3, and output the obtained information through the user interface.

The home appliance 10 may operate according to a control command received from the other home appliance, the user device 2, or the server 3. For example, when the home appliance 10 obtains the user's prior approval to operate according to the control command of the server 3 even if there is no user input, the home appliance 10 may operate according to the control command received from the server 3. Here, the control command received from the server 3 may include a control command input by the user through the user device 2 or a control command based on a predetermined condition, but is not limited thereto.

The user device 2 may transmit information about the user to the home appliance 10 or the server 3 through the communication module. For example, the user device 2 may transmit information about the position of the user, the health condition of the user, the taste of the user, the schedule of the user, and the like to the server 3. The user device 2 may transmit the information about the user to the server 3 according to prior approval by the user.

The home appliance 10, the user device 2, or the server 3 may determine a control command using a technology such as artificial intelligence. For example, the server 3 may receive information about the operation or the status of the home appliance 10, receive the information about the user of the user device 2, process the information using technology such as artificial intelligence, and transmit the processing result or the control command to the home appliance 10 or the user device 2 based on the processing result.

The electronic device according to various embodiments may be one of various types of electronic devices. The electronic devices may include, for example, a display device, a portable communication device (e.g., a smartphone), a computer device, a portable multimedia device, a portable medical device, a camera, a wearable device, or a home appliance. The electronic devices according to an embodiment are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, the singular forms “a,” “an,” and “the” are intended to include the plural forms as well, unless the context clearly indicates otherwise. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, the term “part” or “module” may include a unit implemented in hardware, software, or firmware, and may interchangeably be used with other terms, for example, “logic,” “logic block,” “part,” or “circuitry”. A part or module may be a single integral component, or a minimum unit or part thereof, adapted to perform one or more functions. For example, according to an embodiment, ‘part’ or ‘module’ may be implemented in a form of an application-specific integrated circuit (ASIC).

As used in various embodiments of the disclosure, the term “if” may be interpreted as “when,” “upon,” “in response to determining,” or “in response to detecting,” depending on the context. Similarly, “if A is determined” or “if A is detected” may be interpreted as “upon determining A” or “in response to determining A”, or “upon detecting A” or “in response to detecting A”, depending on the context.

The program executed by the electronic device described herein may be implemented as a hardware component, a software component, and/or a combination thereof. The program may be executed by any system capable of executing computer readable instructions.

The software may include computer programs, codes, instructions, or combinations of one or more thereof and may configure the processing device as it is operated as desired or may instruct the processing device independently or collectively. The software may be implemented as a computer program including instructions stored in computer-readable storage media. The computer-readable storage media may include, e.g., magnetic storage media (e.g., read-only memory (ROM), random-access memory (RAM), floppy disk, hard disk, etc.) and an optically readable media (e.g., CD-ROM or digital versatile disc (DVD). Further, the computer-readable storage media may be distributed to computer systems connected via a network, and computer-readable codes may be stored and executed in a distributed manner. The computer program may be distributed (e.g., downloaded or uploaded) via an application store (e.g., Play Store™), directly between two UEs (e.g., smartphones), or online. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

1. A range hood comprising:
a housing;
at least one thermal imaging camera to be disposed on a rear side of the housing; and
at least one processing circuitry, electrically connectable to the at least one thermal imaging camera, so that while the at least one processing circuitry is connected to the at least one thermal imaging camera, the at least one processing circuitry:
obtains a thermal image through the at least one thermal imaging camera,
identifies a temperature of an object included in the thermal image,
determines an estimated time required for the temperature of the object to reach a preset target temperature based on a changing trend in the temperature of the object, and
displays the estimated time on a display, and
wherein the estimated time is determined after a predetermined time has elapsed from a time the temperature of the object is identified to when a change in the temperature of the object included in the thermal image is detected.

2. The range hood of claim 1, further comprising at least one RGB camera, wherein the at least one RGB camera is disposed on the rear side of the housing.

3. The range hood of claim 2, wherein the at least one RGB camera and the at least one thermal imaging camera are arranged adjacent to each other.

4. The range hood of claim 2, wherein the at least one RGB camera is disposed closer to a front side of the housing than the at least one thermal imaging camera.

5. The range hood of claim 2, wherein the at least one processing circuitry obtains an RGB image using the at least one RGB camera, identifies a food item or a cooking vessel included in the RGB image, sets a first region of interest (ROI) corresponding to the food item or the cooking vessel, sets a second ROI in the thermal image to be mapped to the first ROI, and identifies a temperature of the food item or the cooking vessel based on the second ROI.

6. The range hood of claim 2, wherein the estimated time includes a first estimated time measured at a first time and a second estimated time measured at a second time after the first time, and wherein an interval between the first time and the second time is set to be constant.

7. The range hood of claim 6, wherein the estimated time further includes a third estimated time measured at a third time between the first time and the second time, wherein the third estimated time is measured by the at least one processing circuitry based on identifying from an RGB image obtained through the at least one RGB camera that a new food item is added to a cooking vessel, and
wherein a period when the at least one processing circuitry obtains the RGB image through the at least one RGB camera or obtains the thermal image through the at least one thermal imaging camera is set to be shorter than a period when the at least one processing circuitry measures the estimated time.

8. The range hood of claim 1, wherein the at least one processing circuitry transmits a control command to adjust a heating intensity of a cooktop based on a temperature difference between the temperature and the preset target temperature to the cooktop.

9. The range hood of claim 7, wherein the at least one processing circuitry adjusts a rotational speed of a fan based on at least one of the temperature, the RGB image, or the thermal image.

10. A method for controlling a range hood, the method comprising:
obtaining a thermal image through a thermal imaging camera disposed on a rear side of a housing;
identifying a temperature of an object included in the thermal image;
determining an estimated time required for the temperature of the object to reach a preset target temperature based on a changing trend in the temperature of the object; and
displaying the estimated time on a display,
wherein the estimated time is determined after a predetermined time has elapsed from a time the temperature of the object is identified to when a change in the temperature of the object included in the thermal image is detected.

11. The method of claim 10, wherein the range hood further comprises at least one RGB camera disposed on a rear side of the housing, and wherein the method further comprises:
obtaining an RGB image using the at least one RGB camera;
identifying a food item or a cooking vessel included in the RGB image;
setting a first region of interest (ROI) corresponding to the food item or the cooking vessel;
setting a second ROI in the thermal image to be mapped to the first ROI; and
identifying a temperature of the food item or the cooking vessel based on the second ROI.

12. The method of claim 11, wherein the estimated time includes a first estimated time measured at a first time and a second estimated time measured at a second time after the first time, and wherein an interval between the first time and the second time is set to be constant.

13. The method of claim 12, wherein the estimated time further includes a third estimated time measured at a third time between the first time and the second time, wherein the third estimated time is measured based on identifying from the RGB image obtained through the at least one RGB camera that a new food item is added to the cooking vessel, and
wherein a period when the RGB image is obtained through the at least one RGB camera or the thermal image is obtained through the thermal imaging camera is set to be shorter than a period when the estimated time is measured.

14. The method of claim 10, comprising transmitting a control command for adjusting a heating intensity of a cooktop based on a temperature difference between the temperature and the preset target temperature to the cooktop.

15. The method of claim 11, comprising adjusting a rotational speed of a fan based on at least one of the temperature, the RGB image, or the thermal image.
